(19) United States
(12) Patent Application Publication
(10) Pub. No.: US 2004/0125894 A1
(43) Pub. Date: Jul. 1, 2004

(54) Radio communication apparatus, radio communication system, and communication control method

(75) Inventors: Kenzo Nakamura, Omiya-shi (JP); Kazuyoshi Tari, Omiya-shi (JP); Mototaka Ishikawa, Omiya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI MATERIALS CORPORATION, Tokyo (JP)

(21) Appl. No.: 10/736,542

(22) Filed: Dec. 17, 2003

Related U.S. Application Data
(63) Continuation of application No. 09/439,097, filed on Nov. 12, 1999, now abandoned.

(30) Foreign Application Priority Data
Nov. 11, 1998 (JP) 10-321157

(51) Int. Cl. H04L 27/14; H04L 27/16

(52) U.S. Cl. 375/326; 375/327

(57) ABSTRACT

A radio communication apparatus which uses one of phase shift keying (PSK), differential phase shift keying (DPSK), or quadrature amplitude modulation (QAM), and in which frequency synchronization is achieved based on calculated phase difference data associated with a received signal at time intervals shorter than symbol intervals. The radio communication apparatus includes a frequency synchronization control unit for correcting a frequency of a reference signal used to achieve frequency synchronization in accordance with a mean value of the phase difference data calculated over a period of time in which two or more symbols are input. The radio communication apparatus also includes a phase compensation control unit for adaptively controlling a phase of the received signal when the frequency synchronization control unit achieves frequency synchronization such that an error of the frequency of the reference signal relative to a frequency of the received signal has fallen within a predetermined range, thereby ensuring that frequency synchronization is achieved even when a phase rotation greater than π/4 per cycle occurs.

### CROSS REFERENCE TO RELATED APPLICATION

This application claims priority to Japanese Application No. Hei 10-321157, filed on Nov. 11, 1998, which is incorporated in its entirety.

### BACKGROUND OF THE INVENTION

1. Field of the Invention

The present invention relates to a radio communication apparatus, a radio communication system using phase shift keying (PSK), differential phase shift keying (DPSK), or quadrature amplitude modulation (QAM), in which frequency synchronization is accomplished on the basis of phase difference data, at time intervals shorter than symbol intervals, associated with a received signal. The present invention also relates to a radio communication system including such a radio communication apparatus, and to a communication control method.

2. Discussion of the Background

In the art of digital communication using digital modulation such as quadrature amplitude modulation and phase shift keying, phase locking is performed using, for example, the costas method. In digital modulation, such as QPSK, the phase becomes equal to π/4 at fixed intervals. This property is used to correct the phase error as follows. That is, the value 4 times the angle is determined at the fixed intervals and the phase error is corrected on the basis of the obtained value. However, this causes an instability of π/2. Furthermore, if a phase error greater than π/4 occurs in one period, it is impossible to correct the frequency error.

In narrow-band digital communication systems, a low symbol rate is employed, and thus a frequency offset is a great problem. Therefore, when phase locking is performed using the costas method, a high-stability oscillator dedicated to frequency synchronization is required to achieve a small phase error less than π/4 per symbol interval. However, the employment of such a high-stability oscillator causes an increase in cost.

To quickly achieve frequency synchronization, adaptive phase control using a linear prediction method or the like is conventionally employed. Although this technique is capable of quickly achieving frequency synchronization, a problem is that a training signal is required. Furthermore, as in the costas method, it becomes impossible to achieve synchronization if a phase error greater than π/4 occurs in one period.

Japanese Patent No. 2743826 discloses a radio communication system in which frequency synchronization between primary and secondary stations is achieved as follows. A secondary station reproduces a reference clock signal from a signal received from a primary station and detects a difference in frequency between the reproduced reference clock signal and a reference carrier signal (reference clock) used to transmit a burst signal. The frequency of the reference carrier signal is controlled so that the frequency difference becomes constant, thereby achieving frequency synchronization.

This radio communication system needs a frequency counter for detecting the frequency error. Furthermore, if the frequency of the reference carrier used to transmit a signal is tried to be locked with the reference clock signal extracted from the received signal so as to achieve high-precision synchronization, phase jitter occurs. A phase variation due to modulation is another problem when frequency synchronization is accomplished using the reference clock signal extracted from the received signal. This problem is serious particularly in narrow-band communications.

Japanese Unexamined Patent Publication Nos. 5-75662 and 6-326740 disclose phase locking techniques. However, in these phase locking techniques, a problem also occurs when there is a phase error greater than π/4, and the problem of phase jitter is not solved in these techniques.

Japanese Unexamined Patent Publication Nos. 6-318963 and 6-197140 disclose techniques of handling phase errors greater than π/4 by arbitrarily offsetting the frequency. However, the offsetting of the frequency can cause an error or instability in frequency synchronization when the occurrence of some particular data is great compared with other data.

Japanese Unexamined Patent Publication No. 6-261089 discloses a technique of correcting a phase error greater than π/4 by reducing the sampling interval. In this technique, a phase difference is determined within one symbol period, and the phase error is determined from the phase difference and the phase rotation direction (polarity). However, phase jitter can cause a problem when the phase difference is determined within one symbol period. Another problem of this technique is ambiguity which occurs when a phase rotation greater than π/4 occurs. Furthermore, when the roll-off factor is small, a problem can occur if the phase error is determined from the polarity of a signal passed through a bandpass filter.

### SUMMARY OF THE INVENTION

Accordingly, one object of the present invention is to solve the above-noted and other problems.

Another object of the present invention is to provide a radio communication apparatus, a radio communication system, and a communication control method, in which frequency synchronization and high-precision phase compensation is achieved, even when a phase rotation greater than π/4 occurs in one period.

To achieve these and other objects, the present invention provides a radio communication apparatus which uses one of phase shift keying (PSK), differential phase shift keying (DPSK), or quadrature amplitude modulation (QAM), and in which frequency synchronization is achieved based on calculated phase difference data associated with a received signal at time intervals shorter than symbol intervals. The radio communication apparatus includes a frequency synchronization control unit for correcting a frequency of a reference signal used to achieve frequency synchronization in accordance with a mean value of the phase difference data calculated over a period of time in which two or more symbols are input. The radio communication apparatus also includes a phase compensation control unit for adaptively controlling a phase of the received signal when the frequency synchronization control unit achieves frequency synchronization such that an error of the frequency of the reference signal relative to a frequency of the received signal has fallen within a predetermined range.

### BRIEF DESCRIPTION OF THE DRAWINGS

Various other objects, features and attendant advantages of the present invention will be more fully appreciated as the same becomes better understood from the following detailed description when considered in connection with the accompanying drawings in which like reference characters designate like or corresponding parts throughout the several views and wherein:

FIG. 1 is a block diagram illustrating an embodiment of a radio communication apparatus according to the present invention;

FIG. 2 is a flow chart illustrating a control operation of a frequency synchronization control unit shown in FIG. 1;

FIG. 3 is a flow chart illustrating a control operation of a frequency synchronization control unit shown in FIG. 1;

FIG. 4 is a flow chart illustrating a control operation of a phase compensation control unit shown in FIG. 1;

FIG. 5 is a schematic representation of an adaptive phase control operation;

FIG. 6 is a graph illustrating an example of the adaptive phase control characteristic;

FIG. 7 is a block diagram illustrating main parts of another embodiment of a radio communication apparatus according to the present invention; and

FIG. 8 is a schematic view illustrating a radio communication system according to the present invention.

### DESCRIPTION OF THE PREFERRED EMBODIMENTS

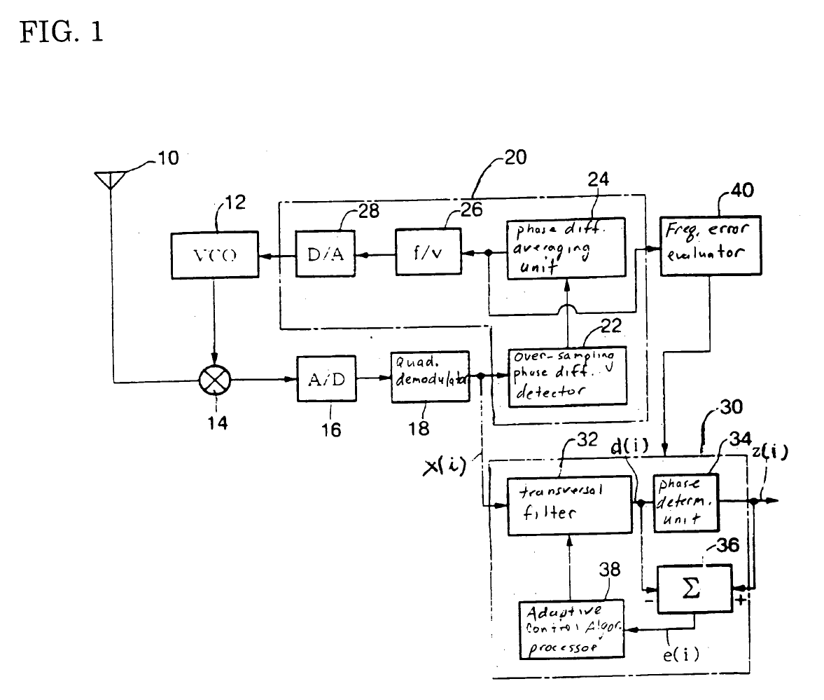

Referring now to the drawings, wherein like reference numerals designate identical or corresponding parts throughout the several views, FIG. 1 illustrates a radio communication apparatus according to a first embodiment of the present invention. As shown in FIG. 1, the radio communication apparatus includes an antenna 10, a voltage controlled oscillator (VCO) 12 for generating a carrier reference signal used to convert a QPSK (quadrature phase shift keying) signal received via the antenna 10 into a baseband signal, and a multiplier 14. Also included is an analog-to-digital converter 16 for converting the output of the multiplier 14 from analog form into digital form, and a quadrature demodulator 18 for converting, by quadrature demodulation, the baseband signal into an in-phase component (I) and a quadrature component (Q).

The radio communication further includes an over-sampling phase difference detector 22, which over-samples the output of the quadrature demodulator and detects phase difference data at time intervals shorter than symbol intervals over a period of time in which two or more symbols are input. Also included is a phase difference averaging unit 24 for calculating a mean value of the phase difference data output from the over-sampling phase difference detector 22, a frequency-to-voltage converter 26 for converting into a voltage form the frequency error data which is output from the phase difference averaging unit 24 and which indicates an error of the frequency of the reference carrier signal output from the voltage controlled oscillator 12 relative to the received signal, and a digital-to-analog converter 28 for converting the output signal of the frequency-to-voltage converter 26 from digital form into analog form.

As shown, a frequency synchronization control unit 20 includes the over-sampling phase difference detector 22, the phase difference averaging unit 24, the frequency-to-voltage converter 26, and the digital-to-analog converter 28. Using the mean value of the phase difference data associated with the received signal, calculated over a period of time in which two or more symbols are input, the frequency synchronization control unit 20 corrects the frequency of the output signal of the voltage controlled oscillator 12 serving as the reference signal used to achieve frequency synchronization with the received signal, such that the frequency error of the reference signal relative to the received signal becomes smaller than a predetermined maximum allowable frequency error.

The radio communication apparatus according to the first embodiment further includes a phase compensation control unit 30 for precisely controlling a phase compensation of the demodulated signal output from the quadrature demodulator 18. The phase compensation control unit 30 includes a transversal filter 32 serving as an adaptive phase control filter, a phase determination unit 34 for detecting a phase space to which the demodulated symbol data corresponds, on the basis of the output of the transversal filter 32, a subtractor 36 for subtracting the output of the transversal filter 32 from the output of the phase determination unit 34, and an adaptive control algorithm processor 38 for determining the coefficient of taps of the transversal filter 32 so as to minimize the phase error data output from the subtractor 36. The phase compensation control unit 30 forms a fractionally spaced equalizer which needs no training signal when performing phase compensation control.

In the present embodiment, the adaptive control algorithm processor 38 employs an LMS (least means square) algorithm. However, other adaptive control algorithms, such as an RLS (recursive least square) algorithm, may also be employed.

The radio communication apparatus also includes a frequency error evaluator 40 which acquires an operation result output from the phase difference averaging unit 24 and determines whether the frequency synchronization control performed by the frequency synchronization control unit 20 has reduced the frequency error of the reference signal output from the voltage controlled oscillator 12 relative to the received signal to a level within a predetermined range which allows the phase compensation control unit 30 to perform adaptive phase control. In this specific embodiment, the predetermined range which allows the phase compensation control unit 30 to perform adaptive phase control is π/4 represented in phase for one cycle.

If the frequency error evaluator 40 has determined that the frequency synchronization control performed by the frequency synchronization control unit 20 has reduced the frequency error of the reference signal output from the voltage controlled oscillator 12 relative to the received signal to a level within the predetermined range which allows the phase compensation control unit 30 to perform adaptive phase control, the phase compensation control unit 30 performs adaptive phase control on the demodulated signal output from the quadrature demodulator 18 in accordance with the evaluation result output from the frequency error evaluator 40. In this embodiment, a response speed of the frequency correction control performed by the frequency synchronization control unit 20 is set to be slower than a response speed of the adaptive phase control performed by the phase compensation control unit 30. This allows a control loop formed by the frequency synchronization control unit 20 to have a narrow band.

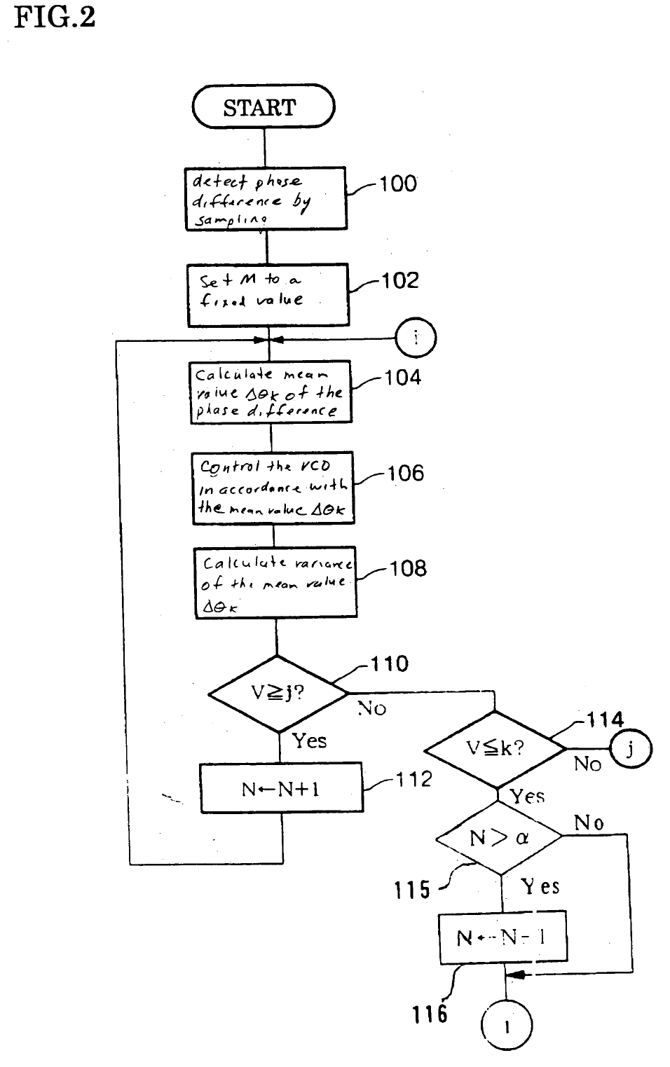

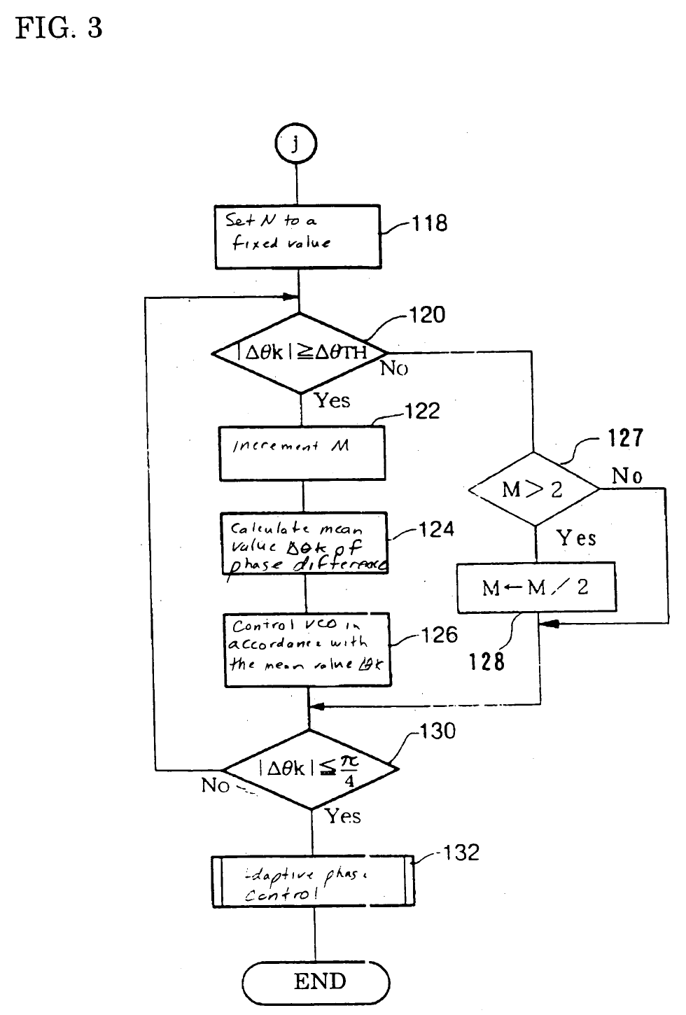

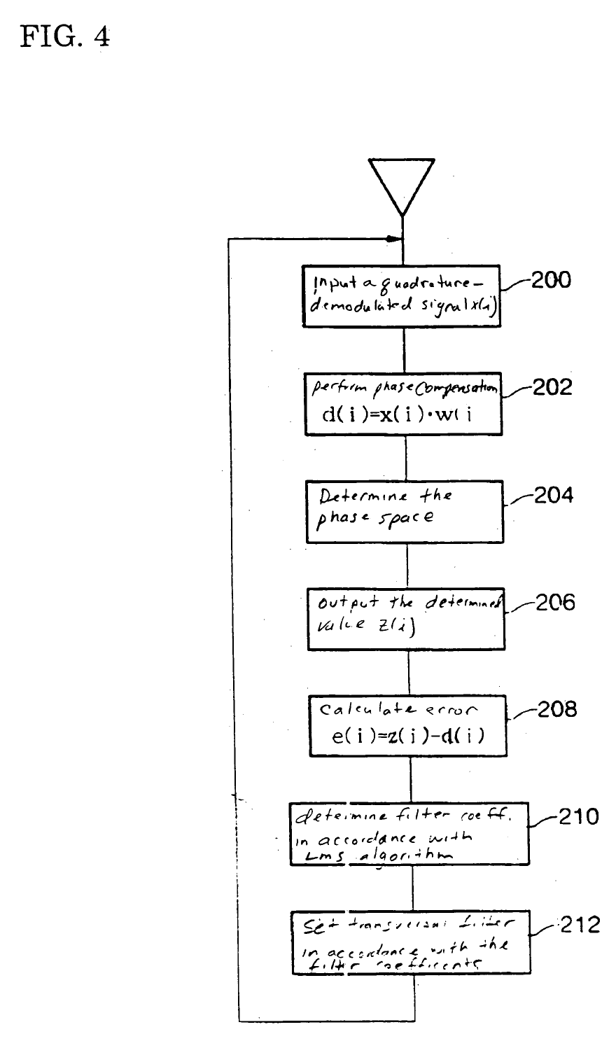

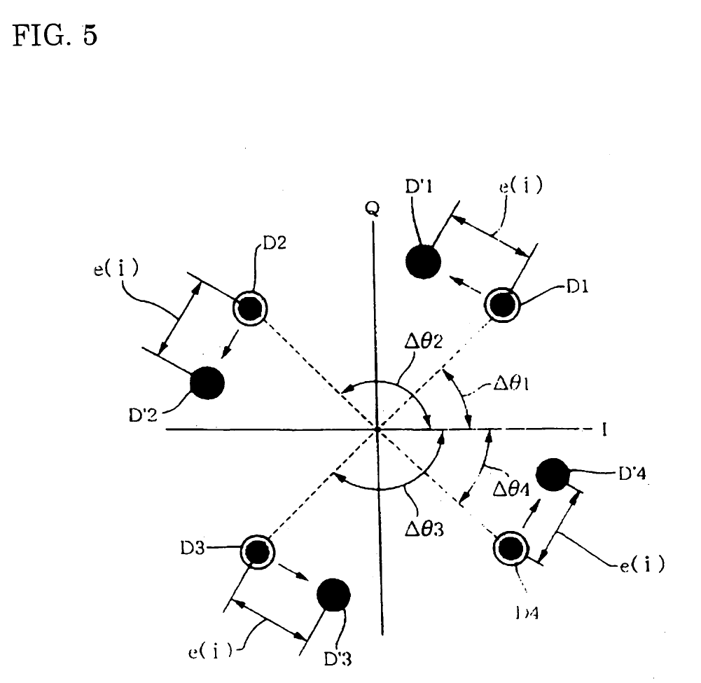

Referring to FIGS. 2 to 6, an operation of the radio communication apparatus of the present embodiment will now be described. FIGS. 2 and 3 illustrate the control process performed by the frequency synchronization control unit 20, and FIG. 4 illustrates the control process performed by the phase compensation control unit 30. If a signal is received via the antenna 10, the multiplier 14 multiplies the received signal by the reference carrier signal (with a frequency of fc) output by the voltage controlled oscillator 12 thereby converting it to a baseband signal. The baseband signal is then converted from an analog form into a digital form by the analog-to-digital converter 16, and the resultant signal is input to the quadrature demodulator 18. The quadrature demodulator 18 converts, by quadrature demodulation, the baseband signal in digital form into an in-phase component (I component) and a quadrature component (Q component).

Subsequently, frequency synchronization control is performed by the frequency synchronization control unit 20 as shown in FIGS. 2 and 3. That is, in step 100, the over-sampling phase difference detector 22 performs over-sampling on the demodulated output x(i) output from the quadrature demodulator 18 and detects phase difference data at time intervals shorter than symbol intervals. The demodulated signal x(i) can be represented as

x(i)=rk·exp{j(φ+2πΔfkT)} (1)

where rk is the amplitude, φ is the phase of the modulation signal, Δfk is the frequency deviation, and T is the sampling interval. The phase difference averaging unit 24 then calculates the mean value Δθk of the phase difference according to equation (2) described below.

$$Δ {θ}_{k} = \frac{1}{N} {\sum }_{n = 0}^{N - 1} ( a n \cdot φ / M + 2 πΔ f n T / M ) = 2 πΔ f T / M \qquad ( 2 )$$

where M is the over-sampling number, N is the number of data used in the averaging calculation, and “an” is the transfer function after the filtering.

In step 102, the over-sampling number M in equation (2) is fixed to a particular value. After that, in accordance with equation (2), the phase difference averaging unit 24 calculates the phase difference mean value Δθk over a period of time in which several symbols of the demodulated signal are output (step 104). The frequency deviation (i.e., the frequency error Δf obtained in correspondence with the phase difference mean value Δθk calculated in step 104) is then converted to a voltage value by the frequency-to-voltage converter 26 and applied to the voltage controlled oscillator 12 via the digital-to-analog converter 28. As a result the frequency of the reference carrier signal output from the voltage controlled oscillator 12 is corrected such that the frequency error Δ is reduced (step 106).

In the next step 108, the variance V of the mean phase difference Δθk obtained in step 104 is calculated. Then, it is determined in step 110, whether or not the variance V is greater than a predetermined value j, thereby determining whether or not the control loop formed by the frequency synchronization control unit 20 is in a stable state. If it is determined that V≧j (i.e., if it is determined that the control loop is in an unstable state), the number of data N is incremented by +1 in the next step 112. After that, the process returns to step 104, and steps 104 to 108 are repeated. As a result of the increase in the number of data N, imbalance in occurrence of data is leveled and noise is reduced. Thus, the control loop is brought into a stable state from an unstable state due to an imbalance in occurrence among data or due to a large phase noise.

On the other hand, if it is determined in step 110 that V<j, the process goes to step 114 to determine whether or not V<k (where k<j). That is, it is determined whether or not the control loop has come into a sufficiently stable state from the above-described unstable state. Here, k is a value of the variance V of the mean phase difference Δθk obtained when the control loop is in the sufficiently stable state. When it is determined that V≦k in step 114, it is further determined in step 115 whether or not N>α (where α is an arbitrary integer). This judgement is necessary because the mean phase difference Δθk will diverge if N becomes equal to 0 as a result of the process performed in step 116. If N>α, the process goes to step 116. However, the process goes to step 104 if N≦α. If it is determined in step 115 that N>α, the process goes to step 116, and the number of data N is decremented by 1. After that, the process returns to step 104, and steps 104 to 108 are repeated until the number of data N is optimized. If the number of data N becomes large, data occurs in a more random fashion (i.e., the occurrence probability becomes similar for any data), and thus the frequency error becomes small. However, the increase in the number of data N results in an increase in the convergence time of the control system. Thus, it is required to optimize the number of data N in the above-described process.

On the other hand, if it is determined in step 114 that k<V<j (i.e., if the control loop has become moderately stable although not sufficiently stable), the process goes to step 118 shown in FIG. 3, and the number of data N in equation (2) is fixed to a particular value. In the next step 120, the absolute value |Δθk| of the mean phase difference Δθk is compared with a threshold value ΔθTH, where ΔθTH>π/4M. If it is determined in step 120 that |Δθk|≧ΔθTH, the over-sampling number M in equation (2) is increased (step 122), and the process then goes to step 124.

On the other hand, if it is determined in step 120 that |Δθk|<ΔθTH, it is further determined in step 127 whether or not the over-sampling number M is greater than 2. If it is determined in step 127 that M>2, the process goes to step 128, and the over-sampling number M is reduced to M/2. After that, the process goes to step 130. On the other hand, if it is determined in step 127 that M≦2, the process goes directly to step 130. In the above process, the increase or decrease in the over-sampling number M depending on the result of comparison of the absolute value |Δθk| of the mean phase difference Δθk is required because the accuracy of detection of the frequency error decreases with the reduction in the mean phase difference Δθk or the frequency error Δf. That is, the reduction in the accuracy of detection of the frequency error is prevented by adjusting the value of the over-sampling number M depending on the result of the calculation of equation (2). Here, the increase/decrease in the over-sampling number M corresponds to the increase/decrease in the sampling time. In the first embodiment, as descried above, the accuracy of detection of the frequency error is improved by adaptively controlling the increase/decrease of the number of data (corresponding to the sampling number) and the over-sampling number M (corresponding to the sampling time) depending on the frequency error.

After the over-sampling number M in equation (2) is increased in step 122, the mean phase difference Δθk is calculated in step 124 in a similar manner as in step 104. In addition, the frequency of the reference carrier signal generated by the voltage controlled oscillator 12 is corrected in accordance with the resultant mean phase difference Δθk in step 126 in a similar manner in step 106. In step 130, after step 126 or step 128, the frequency error evaluator 40 determines whether |Δθk|≦π/4. That is, the frequency error evaluator 40 determines whether, as a result of the frequency synchronization control performed by the frequency synchronization control unit 20, the frequency error Δf or the mean phase difference |Δθk| has become smaller than a predetermined value which allows the phase compensation control mechanism 30 to properly perform adaptive phase compensation.

If it is determined in step 130 that |Δθk|≧π/4, the process returns to step 120, and steps 120 to 130 are repeated. On the other hand, if it is determined in step 130 that |Δθk|≦π/4, the process goes to step 132 in which the phase compensation control unit 30 performs adaptive phase control in accordance with the result of evaluation made by the frequency error evaluator 40. If it is determined that the error of the frequency of the received signal relative to the reference carrier signal generated by the voltage controlled oscillator 12 has reduced by the frequency synchronization control unit 20 to a level smaller than a predetermined value (smaller than π/4 in phase), communication to a sender may be started on the basis of that frequency. This makes it possible for the sender to accomplish precise phase compensation on a received signal.

The receiving operation may also be performed under conditions in which the frequency error is determined to be within the predetermined range by the frequency error evaluation unit 20. When the receiving operation is again started after a pause, the frequency synchronization control unit 20 performs frequency synchronization control using the frequency of the reference signal at that time such that the error of the frequency of a received signal relative to the reference signal falls within the predetermined range. In addition, when the receiving operation is again started after another pause, the receiving operation is performed using the same frequency of the reference signal as that used in the previous receiving operation. This allows the reference signal used for the frequency synchronization control to be updated at shorter intervals. Thus, it becomes possible to achieve frequency synchronization of the reference signal in a short time even when the ambient temperature varies because of self heating or a variation in environmental conditions.

The adaptive phase control performed by the phase compensation control unit 30 is described below. In step 200 shown in FIG. 4, the signal x(i) output from the quadrature demodulator 18 is input to the transversal filter 32 of the phase compensation control unit 30. Phase compensation is performed on the demodulated signal x(i) in accordance with the filter characteristic determined by the filter coefficients set by the adaptive control algorithm processor 38 (step 202). When the filter characteristic of the transversal filter 32 is given by w(i), the output d(i) of the transversal filter 32 is given as

d(i)=x(i)·w(i) (3)

If the demodulated signal x(i) is given by x(i)=exp{j(ak+2πΔfT)}, the modulation phase component and the phase error of the demodulated signal are given by exp(jak) and e(i)=exp(j2πΔfT), respectively, and if the filter characteristic of the transversal filter 32 is set as w(i)=exp(−j2πΔfT) by the adaptive control algorithm processor 38, the output d(i) of the transversal filter becomes

$$\begin{matrix}d ( i ) = x ( i ) \cdot w ( i ) \\ = exp \{ j ( a k + 2 πΔ f T ) \} \cdot exp ( - j2πΔ f T ) \\ = exp ( j a k )\end{matrix} \qquad ( 4 )$$

Thus, the phase error e(i) is completely eliminated, and the original signal exp(jak) is extracted.

In the case where a 4-phase QPSK signal is demodulated, the phase difference data Δθkm (i.e., the difference in phase between adjacent elements of the phase series {θk} output from the transversal filter 32) falls into one of four quadrants of the I-Q coordinate system. That is, if the I axis is taken as the reference, Δθk (k=1, . . . , 4)=π/4 (first quadrant), 3π/4 (second quadrant), −3π/4 (third quadrant), or −π/4 (fourth quadrant). Thus, the symbol data identified by the demodulated dibit becomes equal to one of reference data D1, D2, D3, and D4 located in the respective quadrants of the I-Q coordinate system.

In practice, however, the transversal filter cannot completely eliminate the phase error, and the output d(i) of the transversal filter 32 includes a residual error e(i). Thus, in step 204, the phase determination unit 34 determines in which quadrant, in the orthogonal I-Q coordinate system, the phase difference obtained from the output d(i) of the transversal filter 32 lies. The phase determination unit 34 then determines that the input symbol data corresponds to the reference data assigned to the quadrant in which the input phase difference data Δθk has been found to lie, and outputs the determined data (step 206). Here, the output of the phase determination unit 34 is represented by z(i).

In the next step 208, the subtractor 36 calculates the phase error e(i) in accordance with equation (5) shown below.

e(i)=z(i)−d(i) (5)

The calculated phase error e(i) is input to the adaptive control algorithm processor 38. The adaptive control algorithm processor 38 processes the phase error e(i) in accordance with the LMS algorithm so as to determine the filter coefficients of the transversal filter 32 such that the phase error e(i) is minimized. The transversal filter 32 is then set in accordance with the resultant filter coefficients (steps 210 and 212).

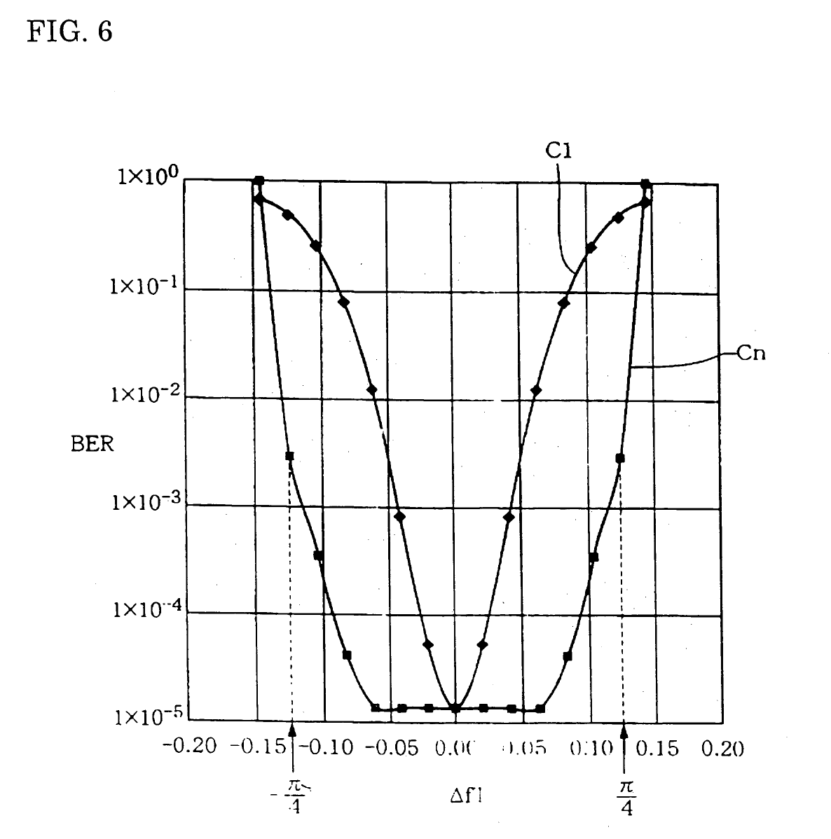

Thus, as a result of the high-precision phase compensation, the phase error e(i) falls within π/4 in absolute value as shown in FIG. 6. FIG. 6 shows an example of the frequency error characteristic. In FIG. 6, the horizontal axis represents the frequency error ΔfT, and the vertical axis represents the bit error rate (BER). Curve C1 represents the frequency error characteristic obtained after the phase compensation by the phase compensation control mechanism 30, and curve Cn represents the limit of the frequency error (the limit of the phase error) acceptable by the phase compensation control mechanism 30 to perform phase compensation. In FIG. 6, a frequency error ΔfT equal to 0.125 corresponds to a phase error of π/4.

In this first embodiment of the radio communication apparatus which uses QPSK and in which frequency synchronization is achieved on the basis of the phase difference data, at time intervals shorter than symbol intervals, associated with a received signal, the frequency of the reference signal used to achieve frequency synchronization is corrected by the frequency synchronization control mechanism in accordance with the mean value of the phase difference data calculated over a period of time in which two or more symbols are input. Thereby, it is ensured that frequency synchronization can be achieved even when a phase rotation greater than π/4 per cycle occurs, without using a high-stability oscillator especially designed for frequency synchronization.

In addition, in the first embodiment, the frequency of the reference signal used to achieve frequency synchronization with the received signal is corrected by the frequency synchronization control mechanism in accordance with the mean value of the phase difference data calculated over a period of time in which two or more symbols are input such that the error of the frequency of the reference signal relative to the frequency of the received signal falls within the predetermined range acceptable to perform phase compensation by the adaptive phase control. Also, the received and demodulated signal is subjected to adaptive phase control performed by the phase compensation control unit after frequency synchronization has been achieved. This results in a reduction in the frequency synchronization error due to a frequency offset.

Furthermore, the circuit loop for the frequency synchronization is allowed to have a narrow band, and thus no phase jitter occurs. As a result, the phase compensation control unit can operate in a stable fashion. Thus, high-precision phase control is achieved. That is, the reliability of the demodulated data is improved.

Also, in the first embodiment, frequency synchronization is accomplished by a combination of the correction of the frequency of the reference signal by the frequency synchronization control unit and the fractionally spaced equalizer serving as the phase compensation unit, thereby ensuring that high-precision frequency synchronization is achieved without needing a training signal.

Although in the first embodiment QPSK is employed as the digital modulation method, other methods such as DPSK, QAM, etc., may also be employed to achieve similar features and advantages to those obtained in the first embodiment of the invention.

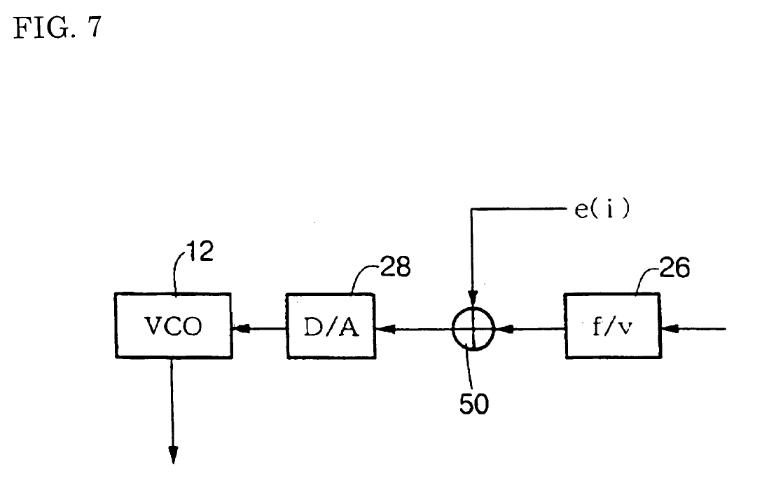

FIG. 7 illustrates main parts of a second embodiment of a radio communication apparatus according to the present invention. This radio communication apparatus is different in construction from that of the first embodiment shown in FIG. 1 in that a phase error e(i) output from the subtractor 36 of the phase compensation control unit 30 is added, via an adder 50, with the output of the frequency-to-voltage converter 26 of the frequency synchronization control unit 20, thereby correcting the output of the frequency-to-voltage converter 26. The voltage controlled oscillator 12 is controlled using the resultant corrected control data as the control signal so as to control the frequency synchronization. The other parts are similar to those of the first embodiment, and thus they are not described in further detail.

In addition to the advantages and features of the first embodiment, the radio communication apparatus according to the second embodiment further has the advantage that phase compensation for the frequency synchronization can be performed in a more precise fashion than can be in the first embodiment.

Also, in the radio communication apparatus according to the second embodiment, communication to a sender may be started after the frequency of the reference carrier signal generated by the voltage controlled oscillator is set in accordance with the corrected control data described above. This makes it possible for the sender to accomplish precise phase compensation on a received signal.

Furthermore, in the radio communication apparatus according to the second embodiment, the frequency of the reference carrier signal generated by the voltage controlled oscillator which has been set in accordance with the corrected control data described above may be employed in a subsequent receiving operation. This makes it possible to accomplish precise phase compensation in the subsequent receiving operation.

Although QPSK is also employed as the digital modulation method in the second embodiment as in the first embodiment, other methods such as DPSK, QAM, etc., array also be employed to achieve similar features and advantages to those obtained in the second embodiment of the invention.

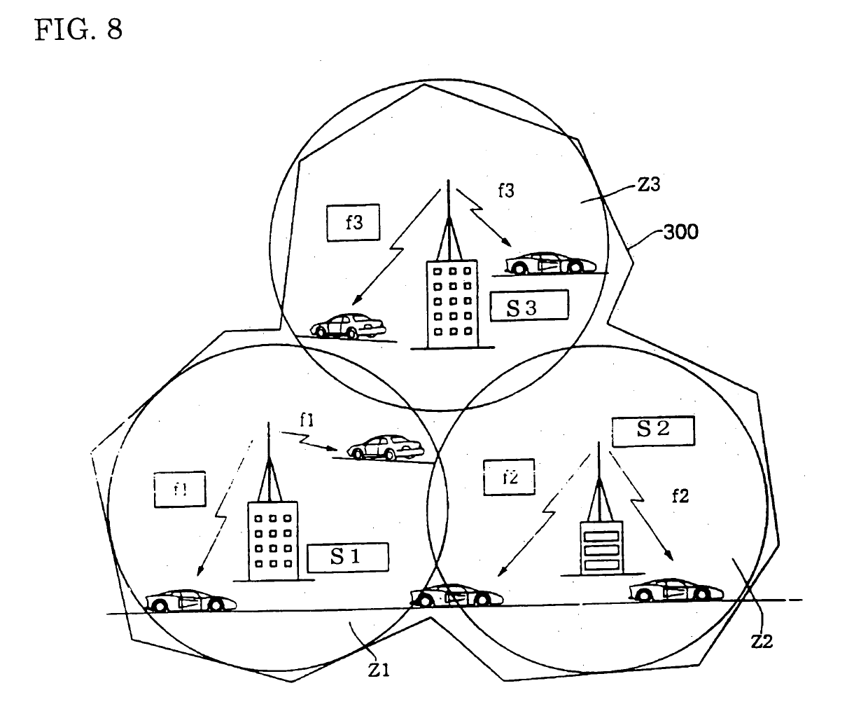

FIG. 8 illustrates an example of a radio communication system according to the present invention. In FIG. 8, a service area 300 includes a plurality of zones Z1, Z2, and Z3. In each zone, communication between a base station and a mobile station is performed using two frequencies one of which is used for upstream transmission and the other is used for downstream transmission. The respective base stations in each zone Z1, Z2, and Z3 use different frequencies f1, f2, and f3 for communication. This radio communication system employs a two-frequency simplex method in which each base station in the zones Z1, Z2, and Z3 continuously transmits a signal to a corresponding mobile station, whereas each base station performs communication using a burst signal. In this radio communication system, some of or all of the techniques disclosed in the above embodiments of the invention may be applied.

In addition, in this radio communication system, frequency synchronization can be achieved even when a phase rotation greater than π/4 per cycle occurs, without using a high-stability oscillator specially designed for frequency synchronization.

In the radio communication apparatus which uses phase shift keying (PSK), differential phase shift keying (DPSK), or quadrature amplitude modulation (QAM), and in which frequency synchronization is achieved on the basis of the phase difference data, at time intervals shorter than symbol intervals, associated with a received signal, and which includes frequency synchronization control unit for correcting the frequency of the reference signal used to achieve frequency synchronization, in accordance with the mean value of the phase difference data calculated over a period of time in which two or more symbols are input, a computer program for implementing the functions of this radio communication apparatus may be stored on a computer readable storage medium, and the program may be loaded onto a computer system and executed thereby accomplishing frequency synchronization control.

In this case, the program which implements the function of the frequency synchronization is stored on the storage medium, and the program is loaded onto the computer system and executed so that frequency synchronization can be achieved even when a phase rotation greater than π/4 per cycle occurs, without using a high-stability oscillator specially designed for frequency synchronization.

Furthermore, in the radio communication apparatus which uses phase shift keying (PSK), differential phase shift keying (DPSK), or quadrature amplitude modulation (QAM), and in which frequency synchronization is achieved on the basis of the phase difference data, at time intervals shorter than symbol intervals, associated with a received signal, and which includes a frequency synchronization control unit for correcting the frequency of a reference signal used to achieve frequency synchronization with a received signal, in accordance with the mean value of the phase difference data calculated over a period of time in which two or more symbols are input such that the error of the frequency of the reference signal relative to the frequency of the received signal falls within a predetermined range, and a phase compensation control unit for adaptively controlling the phase of the received signal when frequency synchronization has been achieved by frequency control performed by the frequency synchronization unit such that the error of the frequency of the reference signal relative to the frequency of the received signal has fallen within the predetermined range, a computer program for implementing the functions of this radio communication apparatus may be stored on a computer readable storage medium, and the program may be loaded onto a computer system and executed thereby accomplishing frequency synchronization control and phase compensation control.

In this case, the program which implements the control function is stored on the storage medium, and the program is loaded onto the computer system and executed thereby ensuring that the frequency synchronization is accomplished with a less synchronization error due to a frequency error.

In this case, the circuit loop for the frequency synchronization is allowed to have a narrow band, and thus no phase jitter occurs. As a result, the phase compensation control unit can operate in a stable fashion, and thus high-precision phase control is achieved. That is, the reliability of the demodulated data is improved.

Furthermore, a computer program for implementing the functions of the radio communication apparatus in which a fractionally spaced equalizer is employed as the phase compensation unit may be stored on a computer readable storage medium, and the program may be loaded onto a computer system and executed thereby accomplishing frequency synchronization control and phase compensation control.

In this case, the program which implements the control function is stored on the storage medium, and the program is loaded onto the computer system and executed. This makes it possible to accomplish frequency synchronization by a combination of the correction of the frequency of the reference signal by the frequency synchronization control unit and the fractionally spaced equalizer serving as the phase compensation unit, thereby ensuring that high-precision frequency synchronization is achieved without needing a training signal.

Furthermore, a computer program for implementing the functions of the radio communication apparatus, in which the response speed of the frequency correction control performed y the frequency synchronization control unit is set to be slower than the response speed of the adaptive phase control performed by the phase compensation control unit, may be stored on a computer readable storage medium, and the program may be loaded onto a computer system and executed thereby accomplishing frequency synchronization control and phase compensation control.

In this case, the program which implements the control function is stored on the storage medium, and the program is loaded onto the computer system and executed. This allows the frequency synchronization control unit forming a control loop for performing frequency synchronization to have a narrow band.

Furthermore, a computer program for implementing the functions of the radio communication apparatus, in which the frequency synchronization control means adaptively increases or decreases the sampling number and the sampling time of the phase difference data subjected to the mean value calculation, in accordance with the error of the frequency, may be stored on a computer readable storage medium, and the program may be loaded onto a computer system and executed thereby accomplishing frequency synchronization control and phase compensation control.

In this case, the program which implements the control function is stored on the storage medium, and the program is loaded onto the computer system and executed. This makes it possible to achieve an improvement in the detection accuracy of the frequency error.

Furthermore, a computer readable storage medium may store a computer program for implementing the functions of the radio communication apparatus which includes a frequency error evaluation unit for determining whether the error of the frequency of a received signal relative to the frequency of the reference signal has fallen within the predetermined range after the frequency correction of the reference signal, and in which if the frequency error evaluation unit has determined that the error of the frequency is within the predetermined range, communication to a sender is started on the basis of that frequency, and the program may be loaded onto a computer system and executed thereby controlling the communication process.

In this case, the program which implements the control function is stored on the storage medium, and the program is loaded onto the computer system and executed. This eases the frequency synchronization in the sender apparatus.

Furthermore, a computer readable storage medium may store a computer program for implementing the functions of the radio communication apparatus in which control data used to control the frequency of the reference signal and corresponding to the frequency correction value required to achieve frequency synchronization in the frequency correction control performed by the frequency synchronization control unit is corrected by a correction value corresponding to the value of phase compensation made via adaptive phase control by the phase compensation control unit, and the frequency of the reference signal is set in accordance with the corrected control data, and then communication to a sender is started, and the program may be loaded onto a computer system and executed thereby controlling the communication process.

In this case, the program which implements the control function is stored on the storage medium, and the program is loaded onto the computer system and executed thereby making it possible for the sender to accomplish precise phase compensation on a received signal.

Furthermore, a computer readable storage medium may store a computer program for implementing the functions of the radio communication apparatus in which a receiving operation is performed under the conditions in which the frequency error is determined to be within the predetermined range by the frequency error evaluation unit; when the receiving operation is again started after a pause, the frequency synchronization control unit performs frequency synchronization control using the frequency of the reference signal at that time such that the error of the frequency of a received signal relative to the reference signal falls within the predetermined range; and when the receiving operation is again started after another pause, the receiving operation is performed using the same frequency of the reference signal as that used in the previous receiving operation, and the program may be loaded onto a computer system and executed thereby controlling the communication process.

In this case, the program which implements the control function is stored on the storage medium, and the program is loaded onto the computer system and executed thereby making it possible to achieve frequency synchronization of the reference signal in a short time even when the ambient temperature varies because of self heating or a variation in environmental conditions.

Furthermore, a computer readable storage medium may store a computer program for implementing the functions of the radio communication apparatus in which the control data which is used to control the frequency of the reference signal and which corresponds to the frequency correction value required to achieve frequency synchronization in the frequency correction control performed by the frequency synchronization control unit is corrected by the correction value corresponding to the value of phase compensation made via adaptive phase control by the phase compensation control unit, and the frequency of the reference signal set in accordance with the corrected control data is employed in a subsequent receiving operation, and the program may be loaded onto a computer system and executed thereby controlling the communication process.

In this case, the program which implements the control function is stored on the storage medium, and the program is loaded onto the computer system and executed thereby making it possible to accomplish precise phase compensation in the subsequent receiving operation.

Furthermore, a computer readable storage medium may store a computer program for implementing the functions of the radio communication system employing a two-frequency simplex method in which communications between a base station and a plurality of mobile stations are performed in such a manner that the base station continuously transmits a signal whereas mobile stations transmit a burst signal, in which the base station and the mobile stations, or either the base station or the mobile stations, are radio communication apparatus according to the present invention, and the program may be loaded onto a computer system and executed thereby controlling the communication process.

In this case, the program which implements the control function is stored on the storage medium, and the program is loaded onto the computer system and executed thereby ensuring that frequency synchronization can be achieved even when a phase rotation greater than π/4 per cycle occurs, without using a high-stability oscillator specially designed for frequency synchronization.

The “computer system” may include OS and hardware such as a peripheral device. The “computer readable storage medium” is used to refer to a wide variety of storage media. They include a removable/portable medium such as a floppy disk, a magneto-optical disk, a ROM, a CD-ROM, etc., and a storage device such as a hard disk installed in a computer system, for example.

Furthermore, the “computer readable storage medium” also includes a medium which dynamically stores a program for a short time, such as an Internet network, a telephone line, and other communication lines, via which a program is transmitted. In this case, a storage medium such as a volatile memory which is installed in a computer system serving as a server or a client and which stores a program for a certain period of time is also a “computer readable storage medium.” The “program” may be a program which implements some part of the functions described above. Furthermore, the “program” may be such a program which is combined with a program which has been already installed on a computer system to implement the functions described above.

As described above, the present invention has various advantages. That is, in the communication control method according to the present invention, for the radio communication system which uses phase shift keying (PSK), differential phase shift keying (DPSK), or quadrature amplitude modulation (QAM) and in which frequency synchronization between a mobile station and a base station is achieved on the basis of the phase difference data, at time intervals shorter than symbol intervals, associated with a received signal, the frequency of the reference signal used to achieve frequency synchronization is corrected in accordance with the mean value of the phase difference data calculated over a period of time in which two or more symbols are input, thereby ensuring that frequency synchronization is achieved even when a phase rotation greater than π/4 per cycle occurs., without using a high-stability oscillator specially designed for frequency synchronization.

Furthermore, the present invention provides the radio communication apparatus which uses PSK, DPSK or QAM and in which frequency synchronization is achieved on the basis of the phase difference data, at time intervals shorter than symbol intervals, associated with a received signal, in which the frequency of the reference signal used to achieve frequency synchronization is corrected by the frequency synchronization control unit in accordance with the mean value of the phase difference data calculated over a period, of time in which two or more symbols are input, thereby ensuring that frequency synchronization is achieved even when a phase rotation greater than π/4 per cycle occurs, without using a high-stability oscillator specially designed for frequency synchronization.

The present invention also provides the radio communication apparatus which uses PSK, DPSK or QAM and in which frequency synchronization is achieved on the basis of the phase difference data, at time intervals shorter than symbol intervals, associated with a received signal, wherein the frequency of the reference signal used to achieve frequency synchronization with the received signal is corrected by the frequency synchronization control unit in accordance with the mean value of the phase difference data calculated over a period of time in which two or more symbols are input such that the error of the frequency of the reference signal relative to the frequency of the received signal falls within the predetermined range acceptable to perform phase compensation by the adaptive phase control, and the received and demodulated signal is subjected to adaptive phase control performed by the phase compensation control unit after frequency synchronization has been achieved, thereby ensuring that the frequency synchronization is accomplished with a less synchronization error due to a frequency error.

Furthermore, the circuit loop for the frequency synchronization is allowed to have a narrow band, and thus no phase jitter occurs. As a result, the phase compensation control means can operate in a stable fashion, and thus high-precision phase control is achieved. That is, the reliability of the demodulated data is improved.

Preferably, the frequency synchronization is accomplished by a combination of the correction of the frequency of the reference signal by the frequency synchronization control unit and the fractionally spaced equalizer serving as the phase compensation unit, thereby ensuring that high-precision frequency synchronization is achieved without needing a training signal.

Furthermore, the response speed of the frequency correction control performed by the frequency synchronization control unit is preferably set to be lower than the response speed of the adaptive phase control performed by the phase compensation control unit. This allows the frequency synchronization control unit in the control loop for the frequency synchronization to have a narrow band.

Preferably, the sampling number and the sampling time of the phase difference data subjected to the mean value calculation are adaptively increased or decreased by the frequency synchronization control unit in accordance with the error of the frequency. This allows an improvement in the detection accuracy of the frequency error.

Preferably, when the frequency error evaluation unit has determined that the error of the frequency of the reference signal relative to the received signal has fallen within the predetermined range after the frequency correction of the reference signal, communication to a sender is started on the basis of that frequency. This eases the frequency synchronization in the sender apparatus.

Preferably, the control data used to control the frequency of the reference signal and corresponding to the frequency correction value required to achieve frequency synchronization in the frequency correction control performed by the frequency synchronization control unit is corrected by a correction value corresponding to the value of phase compensation made via adaptive phase control by the phase compensation control unit, and the frequency of the reference signal is set in accordance with said corrected control data, and then communication to a sender is started, thereby making it possible for the sender to accomplish precise phase compensation on a received signal.

The frequency synchronization control may be performed using the same frequency of the reference signal as that used in the previous receiving operation, thereby making it possible to achieve frequency synchronization of the reference signal in a short time even when the ambient temperature varies because of self heating or a variation in environmental conditions.

Preferably, the control data which is used to control the frequency of the reference signal and which corresponds to the frequency correction value required to achieve frequency synchronization in the frequency correction control performed by the frequency synchronization control unit is corrected by the correction value corresponding to the value of phase compensation made via adaptive phase control by the phase compensation control unit, and the frequency of the reference signal set in accordance with the corrected control data is employed in a subsequent receiving operation, thereby making it possible to accomplish precise phase compensation in the subsequent receiving operation.

Furthermore, in the radio communication system employing the two-frequency simplex method, the base station and the plurality of mobile stations, or either the base station or the mobile stations, are formed of a radio communication apparatus according to the present invention, thereby ensuring that frequency synchronization can be achieved even when a phase rotation greater than π/4 per cycle occurs, without using a high-stability oscillator specially designed for frequency synchronization.

Furthermore, the present invention provides the communication control method for the radio communication apparatus which uses PSK, DPSK or QAM and in which frequency synchronization is achieved on the basis of the phase difference data, at time intervals shorter than symbol intervals, associated with a received signal, in which frequency synchronization is controlled by correcting the frequency of a reference signal used to achieve frequency synchronization with a received signal, in accordance with the mean value of the phase difference data calculated over a period of time in which two or more symbols are input such that the error of the frequency of the reference signal relative to the frequency of the received signal falls within a predetermined range, and the phase of the received signal is adaptively controlled when frequency synchronization has been achieved, in the step of controlling frequency synchronization, such that the error of the frequency of the reference signal relative to the frequency of the received signal has fallen within the predetermined range, thereby ensuring that the frequency synchronization is accomplished with a less synchronization error due to a frequency error.

In this case, the circuit loop for the frequency synchronization is allowed to have a narrow band, and thus no phase jitter occurs. As a result, the phase compensation control unit can operate in a stable fashion, and thus high-precision phase control is achieved. That is, the reliability of the demodulated data is improved.

In addition, as previously discussed, the present invention also provides a computer program product and corresponding computer readable storage medium to achieve the advantages of the present invention.

Obviously, numerous modifications and variations of the present invention are possible in light of the above teachings. It is therefore to be understood that within the scope of the appended claims, the invention may be practiced otherwise than as specifically described herein.

1. A radio communication apparatus which uses one of phase shift keying (PSK), differential phase shift keying (DPSK), or quadrature amplitude modulation (QAM), and in which frequency synchronization is achieved based on calculated phase difference data associated with a received signal at time intervals shorter than symbol intervals, the radio communication apparatus including:
frequency synchronization control means for correcting a frequency of a reference signal used to achieve frequency synchronization in accordance with a mean value of the phase difference data calculated over a period of time in which two or more symbols are input.

2. A radio communication apparatus according to claim 1, further comprising:
phase compensation control means for adaptively controlling a phase of the received signal when the frequency synchronization control means achieves frequency synchronization such that an error of the frequency of the reference signal relative to a frequency of the received signal has fallen within a predetermined range.

3. A radio communication apparatus according to claim 2, wherein the frequency synchronization control means adaptively increases or decreases a sampling number and a sampling time of the calculated phase difference data subjected to the mean value calculation, in accordance with the error of the frequency of the reference signal relative to the frequency of the received signal.

4. A radio communication apparatus according to claim 2, further including:
frequency error evaluation means for determining whether the error of the frequency of the reference signal relative to the frequency of the received signal has fallen within the predetermined range after the frequency synchronization control means corrects the frequency of the reference signal; and
means for starting communication to a sender based on the frequency within the predetermined range, when the frequency error evaluation means determines that the error is within the predetermined range.

5. A radio communication apparatus according to claim 2, further comprising:
means for correcting, by a correction value corresponding to a value of phase compensation made via adaptive phase control by the phase compensation control means, control data used to control the frequency of the reference signal and which corresponds to a frequency correction value required to achieve frequency synchronization by the frequency synchronization control means;
means for setting the frequency of the reference signal in accordance with the control data corrected by the correcting means; and
means for starting communication to a sender.

6. A radio communication apparatus according to claim 4, further comprising:
means for performing a receiving operation under conditions in which the frequency error evaluation means determines the error is within the predetermined range,
wherein when the receiving operation is again started after a pause, the frequency synchronization control means performs frequency synchronization control using the frequency of the reference signal at that time such that the error of the frequency of the received signal relative to the reference signal falls within the predetermined range, and
when the receiving operation is again started after another pause, the receiving operation is performed using the same frequency of the reference signal as the frequency used in the previous receiving operation.

7. A radio communication apparatus according to claim 2, wherein the phase compensation control means comprises a fractionally spaced equalizer.

8. A radio communication apparatus according to claim 2, further comprising:
means for setting a response speed of frequency correction control performed by the frequency synchronization control means to be lower than a response speed of the adaptive phase control performed by the phase compensation control means.

9. A radio communication apparatus which uses one of phase shift keying (PSK), differential phase shift keying (DPSK), or quadrature amplitude modulation (QAM), and in which frequency synchronization is achieved based on calculated phase difference data associated with a received signal at time intervals shorter than symbol intervals, the radio communication apparatus including:
a frequency synchronization control unit configured to correct a frequency of a reference signal used to achieve frequency synchronization in accordance with a mean value of the phase difference data calculated over a period of time in which two or more symbols are input.

10. A radio communication apparatus according to claim 9, further comprising:
a phase compensation control unit configured to adaptively control a phase of the received signal when the frequency synchronization control unit achieves frequency synchronization such that an error of the frequency of the reference signal relative to a frequency of the received signal has fallen within a predetermined range.

11. A radio communication apparatus according to claim 10, wherein the frequency synchronization control unit adaptively increases or decreases a sampling number and a sampling time of the calculated phase difference data subjected to the mean value calculation, in accordance with the error of the frequency of the reference signal relative to the frequency of the received signal.

12. A radio communication apparatus according to claim 10, further including:
a frequency error evaluator configured to determine whether the error of the frequency of the reference signal relative to the frequency of the received signal has fallen within the predetermined range after the frequency synchronization control unit corrects the frequency of the reference signal,
wherein communication to a sender is started based on the frequency within the predetermined range, when the frequency error evaluator determines that the error is within the predetermined range.

13. A radio communication apparatus according to claim 10, further comprising:
a correcting mechanism configured to correct, by a correction value corresponding to a value of phase compensation made via adaptive phase control by the phase compensation control unit, control data used to control the frequency of the reference signal and which corresponds to a frequency correction value required to achieve frequency synchronization by the frequency synchronization control unit;
a setting mechanism configured to set the frequency of the reference signal in accordance with the control data corrected by the correcting mechanism; and
a starting mechanism configured to start communication to a sender.

14. A radio communication apparatus according to claim 12, wherein a receiving operation is performed under conditions in which the frequency error evaluator determines the error is within the predetermined range,
when the receiving operation is again started after a pause, the frequency synchronization control unit performs frequency synchronization control using the frequency of the reference signal at that time such that the error of the frequency of the received signal relative to the reference signal falls within the predetermined range, and
when the receiving operation is again started after another pause, the receiving operation is performed using the same frequency of the reference signal as the frequency used in the previous receiving operation.

15. A radio communication apparatus according to claim 2, wherein the phase compensation control unit comprises a fractionally spaced equalizer.

16. A radio communication apparatus according to claim 2, further comprising:
a setting mechanism configured to set a response speed of frequency correction control performed by the frequency synchronization control unit to be lower than a response speed of the adaptive phase control performed by the phase compensation control unit.

17. A radio communication method which uses one of phase shift keying (PSK), differential phase shift keying (DPSK), or quadrature amplitude modulation (QAM), and in which frequency synchronization is achieved based on calculated phase difference data associated with a received signal at time intervals shorter than symbol intervals, the radio communication method comprising the steps of:
correcting a frequency of a reference signal used to achieve frequency synchronization in accordance with a mean value of the phase difference data calculated over a period of time in which two or more symbols are input.

18. A radio communication method according to claim 17, further comprising the step of:
adaptively controlling a phase of the received signal when the correcting step achieves frequency synchronization such that an error of the frequency of the reference signal relative to a frequency of the received signal has fallen within a predetermined range.

19. A radio communication method according to claim 18, wherein the correcting step adaptively increases or decreases a sampling number and a sampling time of the calculated phase difference data subjected to the mean value calculation, in accordance with the error of the frequency of the reference signal relative to the frequency of the received signal.

20. A radio communication method according to claim 18, further comprising the steps of:
determining whether the error of the frequency of the reference signal relative to the frequency of the received signal has fallen within the predetermined range after the correcting step corrects the frequency of the reference signal; and
starting communication to a sender based on the frequency within the predetermined range, when the determining step determines that the error is within the predetermined range.

21. A radio communication method according to claim 18, further comprising the steps of:
correcting, by a correction value corresponding to a value of phase compensation made via adaptive phase control by the adaptively controlling step, control data used to control the frequency of the reference signal and which corresponds to a frequency correction value required to achieve frequency synchronization;
setting the frequency of the reference signal in accordance with the corrected control data; and
starting communication to a sender.

22. A radio communication method according to claim 20, further comprising the steps of:
performing a receiving operation under conditions in which the determining step determines the error is within the predetermined range,
wherein when the receiving operation is again started after a pause, the correcting step performs frequency synchronization control using the frequency of the reference signal at that time such that the error of the frequency of the received signal relative to the reference signal falls within the predetermined range, and
when the receiving operation is again started after another pause, the receiving operation is performed using the same frequency of the reference signal as the frequency used in the previous receiving operation.

23. A radio communication method according to claim 18, further comprising the step of:
setting a response speed of frequency correction control performed by the correcting step to be lower than a response speed of the adaptive phase control performed by the adaptively controlling step.

24. A computer program product for executing a radio communication method which uses one of phase shift keying (PSK), differential phase shift keying (DPSK), or quadrature amplitude modulation (QAM), and in which frequency synchronization is achieved based on calculated phase difference data associated with a received signal at time intervals shorter than symbol intervals, the computer program product comprising:
a first computer code configured to correct a frequency of a reference signal used to achieve frequency synchronization in accordance with a mean value of the phase difference data calculated over a period of time in which two or more symbols are input.

25. The computer program product according to claim 24, further comprising:
a second computer code configured to adaptively control a phase of the received signal when the first computer code achieves frequency synchronization such that an error of the frequency of the reference signal relative to a frequency of the received signal has fallen within a predetermined range.

26. The computer program product according to claim 25, wherein the first computer code adaptively increases or decreases a sampling number and a sampling time of the calculated phase difference data subjected to the mean value calculation, in accordance with the error of the frequency of the reference signal relative to the frequency of the received signal.

27. The computer program product according to claim 25, further comprising:
a third computer code configured to determine whether the error of the frequency of the reference signal relative to the frequency of the received signal has fallen within the predetermined range after the first computer code corrects the frequency of the reference signal; and
a fourth computer code configured to start communication to a sender based on the frequency within the predetermined range, when the third computer code determines that the error is within the predetermined range.

28. The computer program product according to claim 25, further comprising:
a third computer code configured to correct, by a correction value corresponding to a value of phase compensation made via adaptive phase control by the second computer code, control data used to control the frequency of the reference signal and which corresponds to a frequency correction value required to achieve frequency synchronization;
a fourth computer code configured to set the frequency of the reference signal in accordance with the control data corrected by the third computer code; and
a fifth computer code configured to start communication to a sender.

29. The computer program product according to claim 27, further comprising:
a fifth computer code configured to perform a receiving operation under conditions in which the third computer code determines the error is within the predetermined range,
wherein when the receiving operation is again started after a pause, the first computer code performs frequency synchronization control using the frequency of the reference signal at that time such that the error of the frequency of the received signal relative to the reference signal falls within the predetermined range, and
when the receiving operation is again started after another pause, the receiving operation is performed using the same frequency of the reference signal as the frequency used in the previous receiving operation.

30. The computer program product according to claim 25, further comprising:
a third computer code configured to set a response speed of the frequency correction control performed by the first computer code to be lower than a response speed of the adaptive phase control performed by the second computer code.

31. A radio communication system employing a two-frequency simplex method in which communications between a base station and a plurality of mobile stations are performed in such a manner that the base station continuously transmits a signal whereas the mobile stations transmit a bust signal,
wherein at least one of the base station and the plurality of mobile stations, comprises:
a frequency synchronization control unit configured to correct a frequency of a reference signal used to achieve frequency synchronization in accordance with a mean value of the phase difference data calculated over a period of time in which two or more symbols are input.

32. The system according to claim 31, wherein the at least one of the base station and the plurality of mobile stations further comprises:
a phrase compensation control unit configured to adaptively control a phase of the received signal when the frequency synchronization control unit achieves frequency synchronization such that an error of the frequency of the reference signal relative to a frequency of the received signal has fallen within a predetermined range.
